(19) United States
(12) Patent Application Publication
(10) Pub. No.: US 2007/0268864 A1
(43) Pub. Date: Nov. 22, 2007

(54) METHOD AND SYSTEM TO ENHANCE SOCIAL NETWORKING THROUGH RANDOM LOCATION CONNECTIVITY

(75) Inventors: VON A. MOCK, BOYNTON BEACH, FL (US); LARRY G. BROWN, ROYAL PALM BEACH, FL (US); ERIC T. EATON, LAKE WORTH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/419,619

(22) Filed: May 22, 2006

(51) Int. Cl. H04Q 7/00

(52) U.S. Cl. 370/331

(57) ABSTRACT

A system (100) and method (500, 600, or 700) of enhancing social networking through random location connectivity can include a transceiver (212) and a processor (210) operatively coupled to the transceiver. The transceiver can be a part of a cellular or camera phone for example. The processor can be programmed to request (502) a random connection to a wireless device in a given local area and receive the random connection to the wireless device among devices on a list of available wireless devices. The system can further include a location server (106) and a social network server (108) that receives the request for the random connection from the transceiver and that has access to the list of available wireless devices in the given local area from the location server. The location server and the social network server can be coupled to each other via the Internet (105).

### FIELD

This invention relates generally to communication devices, and more particularly to a method and system of providing access to certain contact information notwithstanding a locked status.

### BACKGROUND

Communication among individuals in a wireless network is typically selectively and purposefully directed to individuals already known to the user. Although telecommunications generally enhance socialization, in another realm it can also potentially diminish social interaction among people within the same general location. People in general and teens in particular are socially interactive and welcome opportunities to meet new people. Carriers or service providers also wish to increase network traffic as well as mobile phone sales to teens. Although phone users can create call lists and phone books to known parties, existing phones currently do not have a means of encouraging further socialization.

There are a number of mobile blogging and community location applications that enable individuals within a subscription framework to be aware of another individual's location or to receive messaging by opting in to the subscription framework. None of the existing systems provide a framework to randomly call or to contact an individual or object within a general location or vicinity.

### SUMMARY

Embodiments in accordance with the present invention can provide the capability for individuals to communicate with others or objects that they would not have known otherwise. Embodiments herein can involve spontaneous communication with one or more objects or individuals within a given area. Although known grouping frameworks can be used in conjunction with the embodiments, the embodiments utilize a random method to contact an object or individual that is within a given area. The individual contacted may or may not have a known relationship with the person calling or making contact. Applications in accordance with the embodiments can enable individuals to connect with others to generate new interest or form or initiate a way to meet new people that may share common interests.

In a first embodiment of the present invention, a method of enhancing social networking through random location connectivity can include requesting a random connection to a wireless device in a given local area and receiving the random connection to the wireless device among a list of available wireless devices in the given local area. The method can further include the step of randomly selecting the wireless device among the list of available wireless devices in the given local area. Requesting the random connection can involve requesting the random connection from a social server that has access to the list of available wireless devices in the given local area. The social server can obtain or receive the list of available wireless devices in the given local area from a location server. The random connection can be a random connection to a wireless device (or object such as a remote camera coupled to a wireless device) randomly selected from the list of wireless devices in the given local area. The random connection can also be a random connection to a wireless device randomly selected from the list of wireless devices in the given local area further having pre-selected characteristics as determined by a calling party. Note, the list of available wireless devices can be created from a list of wireless devices that have opted-in to a predetermined service.

In a second embodiment of the present invention, another method of enhancing social networking through random location connectivity can include the steps of receiving a request for a random connection to a wireless device in a given local area, requesting a list of available wireless devices in the given local area, and randomly selecting a wireless device from the list of available wireless devices in the given local area. The method can further include the step of receiving the request from a first wireless device and further connecting the first wireless device with a second wireless device randomly selected from the list of available wireless devices in the given local area. The method can also request the list of available wireless devices in the given local area from a location server. The method can also format a request for devices participating in a social network who are in the given local area.

In a third embodiment of the present invention, a system of enhancing social networking through random location connectivity can include a transceiver and a processor operatively coupled to the transceiver. The transceiver can be a part of a cellular phone or a camera phone for example. The processor can be programmed to request a random connection to a wireless device in a given local area and receive the random connection to the wireless device among devices on a list of available wireless devices in the given local area. The system can further include a location server and a social network server that receives the request for the random connection from the transceiver and that has access to the list of available wireless devices in the given local area from the location server. The location server and the social network server can be coupled to each other via the Internet. The random connection can be a random connection to a user of a wireless device in the given local area or to an object coupled to the wireless device in the given local area. The processor can be coupled to a user interface for providing a list of area contacts selectable by a user such as a recent call list that can include a given local area recently called where a call to the given local area from the recent call list generates another call to another randomly selected wireless device within the given local area. Note, the processor can be any suitable component or combination of components, including any suitable hardware or software capable of executing the processes described in relation to the inventive arrangements.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a system of enhancing social networking through random location connectivity in accordance with an embodiment of the present invention.

FIG. 2 is an illustration of a wireless device having a user interface in accordance with an embodiment of the present invention.

FIG. 3 is an illustration of a wireless device having a user interface including recently called areas where a user was called randomly in accordance with an embodiment of the present invention.

FIG. 4 is a system ladder diagram illustrating a method of enhancing social networking through random location connectivity in accordance with an embodiment of the present invention.

FIG. 5 is a flow chart illustrating a method of enhancing social networking through the perspective of a social server in accordance with an embodiment of the present invention.

FIG. 6 is a flow chart illustrating a method of enhancing social networking through the perspective of an initiating wireless device in accordance with an embodiment of the present invention.

FIG. 7 is a flow chart illustrating a method of enhancing social networking through the perspective of a receiving wireless device in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

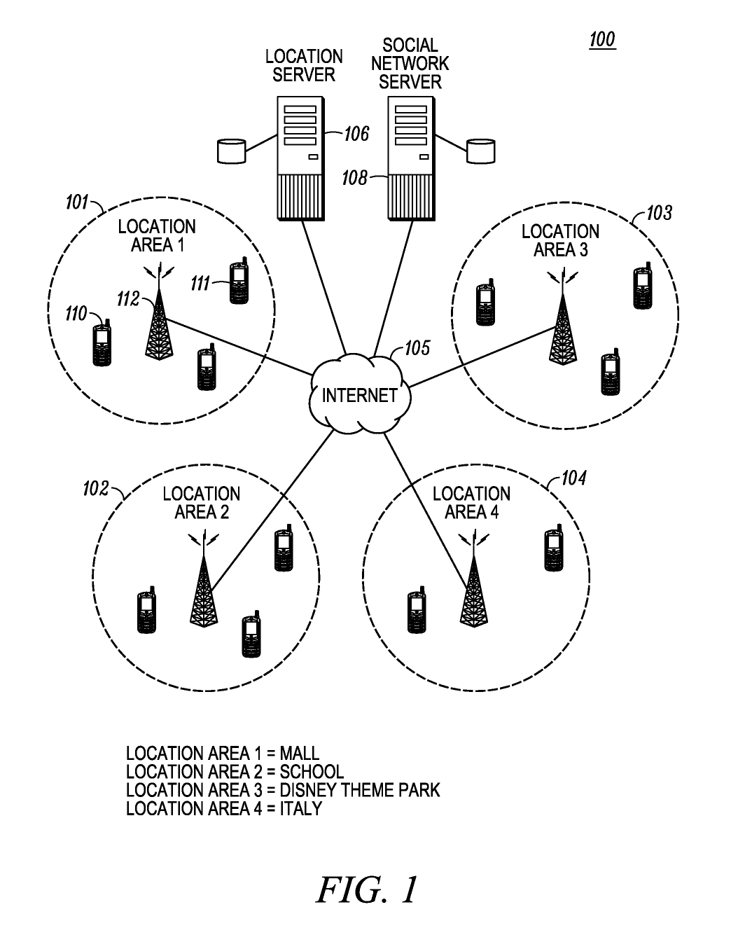

Embodiments in accordance with the present invention are reminiscent of school age kids randomly going through a phone book to randomly find someone to call that they do not know or the old style party line that was first introduced in land line phones. The embodiments herein further provide the dimension of location as a way to determine or narrow a list of potentially randomly called parties. A location server 106 as illustrated in system 100 of FIG. 1 can provide a list of contact candidates to a community server or social network server 108 that can randomly connect two or more individuals (for example, mobile device 110 with mobile device 111 in location area 101). The community can be constructed as an opt-in group where people and objects that want to be randomly contacted join the community and hence a list of available parties ready to receive a random call. Rules can be setup for each individual that determine keep out or prohibited locations, (e.g. home and school) along with time of day to participate. For example, such rules can prohibit such random calls to home and school locations as well as during sleeping hours or school hours. Such rules can be implemented for example by creating a profile that prevents the wireless device from being randomly contacted during a predetermined time of day or in a predetermined location.

Besides the location area 101, the system 100 can further include other different areas such as location areas 102, 103, and 104 which can be a school, a theme park or other predefined area respectively. Each particular area can be serviced by a base station 112 belonging to a communications carrier for example. Each base station in the areas 101-105 can be coupled via the Internet 105 to the location server 106 and the social networking server 108.

In one scenario, the social networking server 108 can be used to randomly meet people when a user is headed to a particular location or local area such as a mall or location 101. If desired, the user can further specify parameters or pre-selected characteristics that they want to meet someone within a particular age range and/or gender to randomly pick someone within the set parameters to talk to. In this manner, a teen or other individual can make new friends and further socialize having some potentially common interests. The parameters or pre-selected characteristics are not limited to age and gender, but can include other parameters such as hobbies, interests or other descriptors that can enhance social interactions. Note, “random” can refer to any process where the result is at least partially unpredictable. “Local area” can refer to any area where participants of the social networking process may be present and ready to receive random requests for communications. Thus, a “local area” in this context is not necessary limited to a geographically close area such as a mall, but can also include expansive areas such as a state, countries, continents or even regions as examples.

In another scenario, the social networking server 108 can be used to randomly obtain pictures from cameras that are in a general area. The new technology can save a trip to the mall if random images that received indicate that the mall was closed. The technology at other times can be used to determine which particular location on a weekend has the most people and the most opportunity to meet other people. Hence, several embodiments enable random spontaneous communication that allows an individual to contact other objects or other people within a mobile environment. Some embodiments can further leverage instant messaging standards to create a Social networking application and system that will help to increase data traffic, handset and application sales.

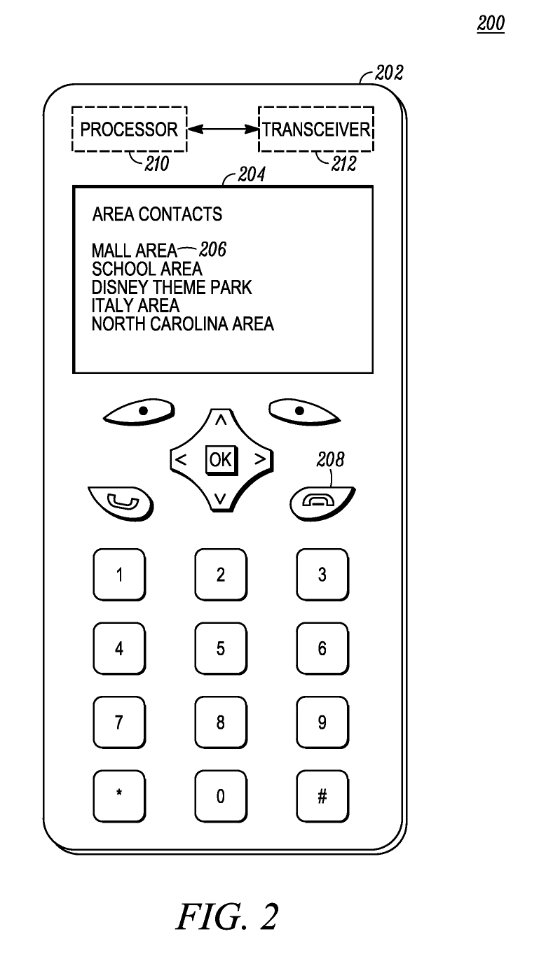

Referring to FIG. 2, a wireless device 200 such as mobile phone 202 can include a processor 210 coupled to a transceiver 212. The device 200 can further include a presentation device 204 such as a screen or display having a user interface showing area contacts 206 created in the phone. The user can initiate a connection using the display and a keypad 208 for example and contact an area that goes through the community server or social network server 108 (see FIG. 1). The social network server 108 works with the location server 106 to randomly choose an object or individual to contact. The presentation device 204 can also provide the user with an indication that an incoming information is part of the random social networking system as opposed to information from another source (such as a typical phone call or Short Messaging Service message).

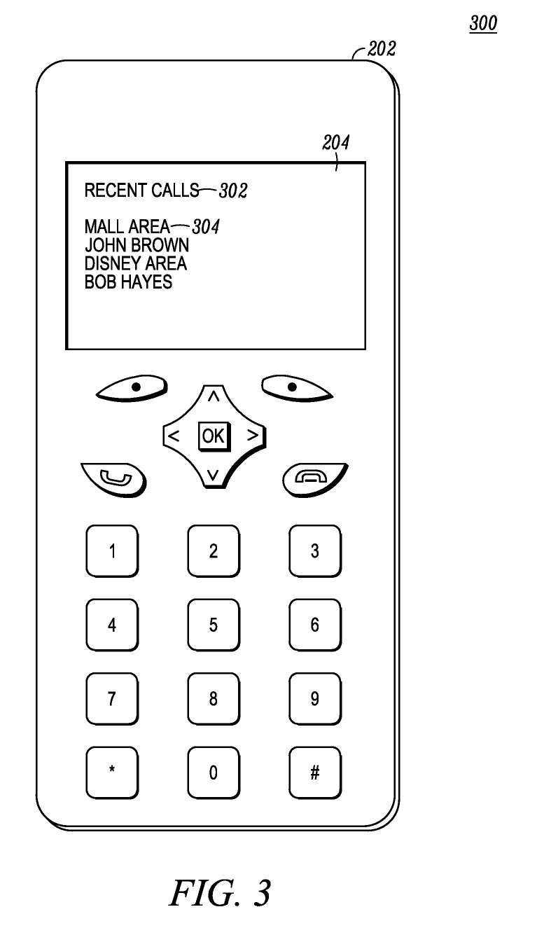

Referring to FIG. 3, a mobile device 300 such as the mobile phone 202 can further integrate areas 304 that have individuals contacted randomly via the function described above. In this regard, the areas 304 can be integrated into a recent call list 302 or function of a cellular phone for example. Thus, using the recent call list and initiating a call to the same area (or another area) will result in a random call to a person in the same area and will not necessarily result in the same person in the recently called being contacted.

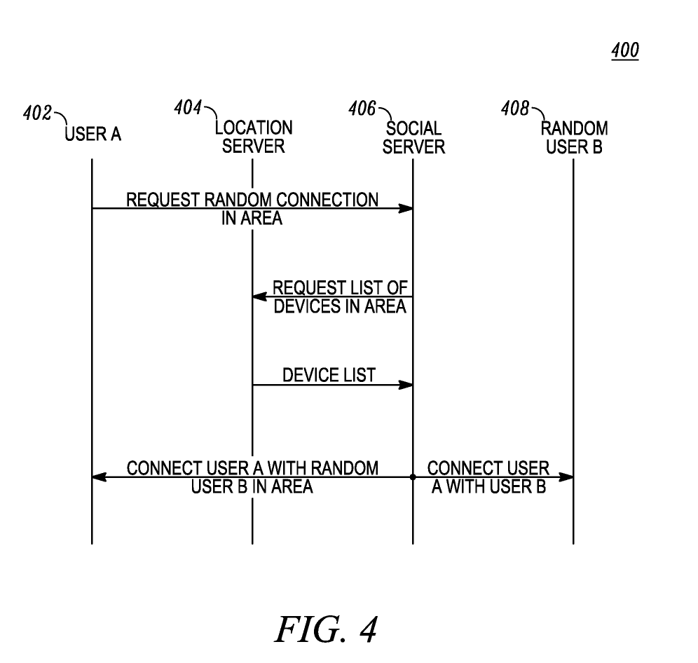

Referring to FIG. 4, a system ladder diagram 400 of Connecting user A (402) with User B (408) is illustrated. User 402 can initiate a call in accordance with an embodiment herein by requesting a random connection to a particular area from a social server 406. The social server 406 in turn will request a list of available devices in the desired area from a location server 404. The location server 404 can provide the list of available devices to the social server 406. Note, the social server can have additional information from user 402 regarding other parameters that would further limit the random selection. The additional parameters can be pre-stored in the social server 406 or can be sent along with the request for the random connection. Once the list is provided to the social server 406, the social server can enable the random connection between user 402 and a randomly selected user B (user 408).

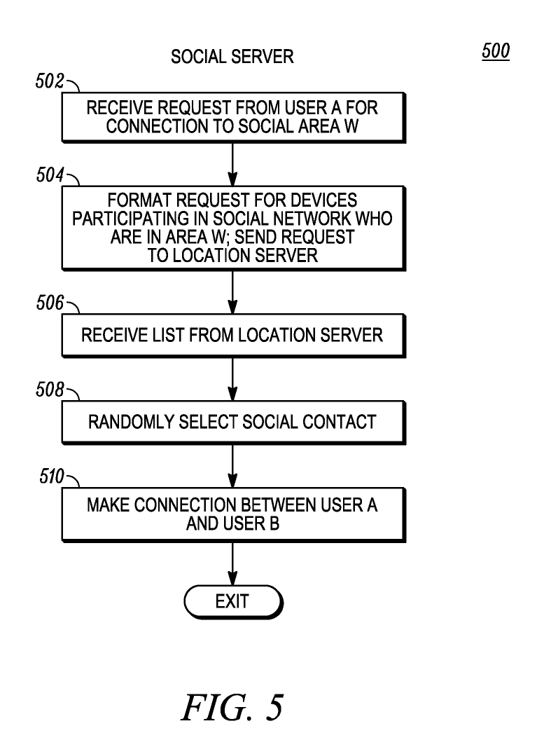

Referring to FIG. 5, a flow chart illustrating a method 500 of enhancing social interaction from the perspective of a social server can include the steps of receiving a request from an initiating handset (or User A) for a random connection to a user (User B) in a predetermined location and/or social group at step 502. The social server can optionally format a request for devices participating in the social network that are in the predetermined location and further send the request to a location server at step 504. At step 506, the method 500 can receive the list from the location server. The social server can then randomly select the social contact among the list at step 508. Thus, a connection can be made between User A and a randomly selected User B at step 510.

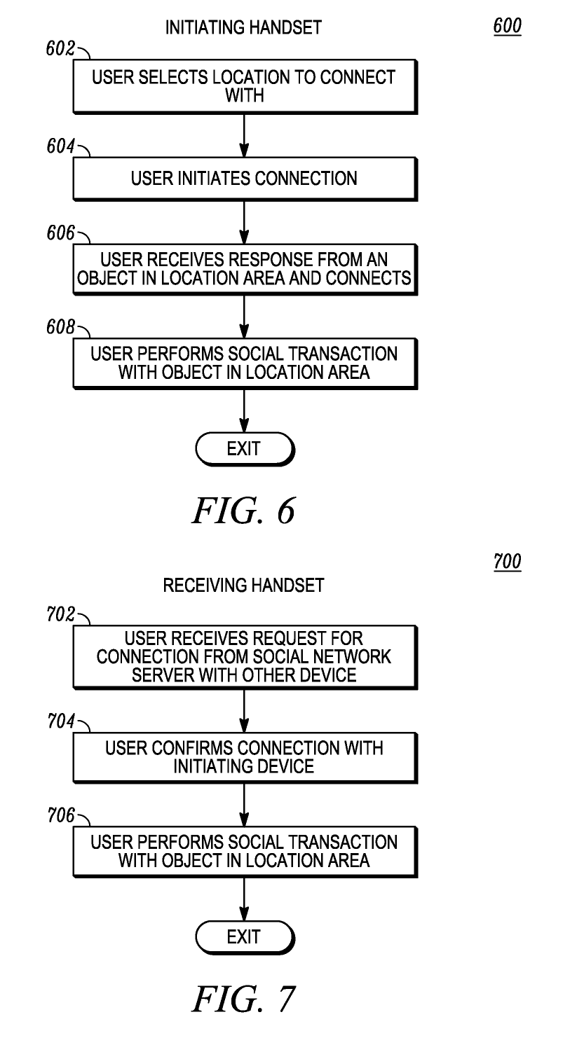

Referring to FIG. 6, a flow chart illustrating a method 600 of enhancing social interaction from the perspective of an initiating handset (User A) can include the step 602 of having the user select a desired location and initiating a random connection at step 604. In this example, User A is attempting to connect to an object such as a remote camera. At step 606, the user can receive a response from the object in the desired or predetermined location and forms a connection. Further, the user can perform a social transaction with the object in the location area at step 608. In this regard, the user can control a camera and possible zoom-in, zoom-out, pan, or possibly have a video conference with someone. Of course, the steps above are equally applicable to a randomly selected user of a cellular phone as well.

Referring to FIG. 7, another flow chart illustrates a method 700 of enhancing social interaction from the perspective of the receiving handset. The method 700 can include the step 702 of receiving a request for a connection from a social network server with another device (such as one used by User A). At step 704, the user (User B) confirms the connection with the initiating device. At step 706, the user performs a social transaction (e.g., simple phone conversation, instant messaging, video conference, video surveillance, audio surveillance etc.) with the object or device in the desired location.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of enhancing social networking through random location connectivity, comprising the steps of:
requesting a random connection to a wireless device in a given local area; and
receiving the random connection to the wireless device among a list of available wireless devices in the given local area.

2. The method of claim 1, wherein the step of requesting comprises requesting the random connection from a social server that has access to the list of available wireless devices in the given local area.

3. The method of claim 2, wherein the method further comprises the step of requesting by the social server the list of available wireless devices in the given local area from a location server.

4. The method of claim 1, wherein the method further comprises the step of creating a profile that prevents the wireless device from being randomly contacted during a predetermined time of day or in a predetermined location.

5. The method of claim 1, wherein the step of receiving the random connection comprises receiving the random connection to a wireless device randomly selected from the list of wireless device in the given local area.

6. The method of claim 1, wherein the random connection to the wireless device is a random connection to a user of a wireless device in the given local area or an object coupled to the wireless device in the given local area.

7. The method of claim 1, wherein the method further comprises the step of randomly selecting the wireless device among the list of available wireless devices in the given local area.

8. The method of claim 1, wherein the list of available wireless devices are created from a list of wireless devices that have opted-in to a predetermined service.

9. The method of claim 1, wherein the step of receiving the random connection comprises receiving the random connection to a wireless device randomly selected from the list of wireless device in the given local area further having pre-selected characteristics as determined by a calling party.

10. A method of enhancing social networking through random location connectivity, comprising the steps of:
receiving a request for a random connection to a wireless device in a given local area;
requesting a list of available wireless devices in the given local area; and
randomly selecting a wireless device from the list of available wireless devices in the given local area.

11. The method of claim 10, wherein the method comprises the step of receiving the request from a first wireless device and further connecting the first wireless device with a second wireless device randomly selected from the list of available wireless devices in the given local area.

12. The method of claim 10, wherein the method requests the list of available wireless devices in the given local area from a location server.

13. The method of claim 10, wherein the method further comprises the step of formatting a request for devices participating in a social network who are in the given local area.

14. A system of enhancing social networking through random location connectivity, comprising:
a transceiver; and
a processor operatively coupled to the transceiver, wherein the processor is programmed to:
request a random connection to a wireless device in a given local area; and
receive the random connection to the wireless device among a list of available wireless devices in the given local area.

15. The system of claim 14, wherein the system further comprises a location server and a social network server that receives the request for the random connection from the transceiver and that has access to the list of available wireless devices in the given local area from the location server.

16. The system of claim 14, wherein the random connection to the wireless device is a random connection to a user of a wireless device in the given local area or to an object coupled to the wireless device in the given local area.

17. The system of claim 14, wherein the processor is coupled to a user interface for providing a list of area contacts selectable by a user.

18. The system of claim 14, wherein the system further comprises a location server and a social network server coupled to each other via the Internet.

19. The system of claim 14, wherein the processor is coupled to a user interface for providing a recent call list that can include a given local area recently called where a call to the given local area from the recent call list generates another call to another randomly selected wireless device within the given local area.

20. The system of claim 14, wherein the transceiver is a part of a cellular phone or a camera phone.
